(19) United States
(12) Patent Application Publication
(10) Pub. No.: US 2026/0219450 A1
(43) Pub. Date: Jul. 30, 2026

(54) SOLID STATE DEVICE INCLUDING AN OPENING OVER A GRATING COUPLER, AND METHOD OF FORMING THE SAME

(71) Applicant: PsiQuantum, Corp., Palo Alto, CA (US)

(72) Inventors: Vijay SUKUMARAN, San Jose, CA (US); Benjamin BRIGGS, Albany, NY (US); Himani KAMINENI, Ballston Spa, NY (US)

(21) Appl. No.: 19/147,550

(22) PCT Filed: Jan. 11, 2024
(86) PCT No.: PCT/US2024/011258

§ 371 Date: Jul. 11, 2025

Related U.S. Application Data
(60) Provisional application No. 63/479,803, filed on Jan. 13, 2023.

(51) Int. Cl. G02B 6/124; G02B 6/12; G02B 6/136; G02B 6/34; G02B 6/42

(52) U.S. Cl. CPC G02B 6/124; G02B 6/12002; G02B 6/12004; G02B 6/136; G02B 6/34; G02B 6/4202; G02B 6/4239; G02B 6/4257; G02B 6/428

(57) ABSTRACT

A solid state device includes a waveguide located on a substrate, a grating coupler connected to the waveguide, and a dielectric layer stack including a bottom dielectric layer portion located on the grating coupler and having an opening formed by conductor lift-off over the bottom dielectric layer portion.

### RELATED APPLICATION

This application claims the benefit of priority from U.S. Provisional Application Ser. No. 63/479,803, filed Jan. 13, 2023, which is incorporated herein by reference in its entirety.

### TECHNICAL FIELD

An embodiment of the present disclosure is directed to a solid state device and more particularly, to a solid state device including an opening over a grating coupler, and method of forming the same.

### BACKGROUND

A grating coupler (GC) may include an optical component (e.g., an integrated-optic component) formed by refractive index modulation in a thin layer on a waveguide. The grating coupler may be used to couple a guided wave and a free-space wave with a surface-coupling scheme. Besides the output or input coupling of the guided wave, the grating coupler may provide (e.g., simultaneously provide) a variety of functions such as focusing, polarization splitting, switching, guided-mode selecting, etc.

### SUMMARY

According to an aspect of the present disclosure, a solid state device includes a waveguide located on a substrate, a grating coupler connected to the waveguide, and a dielectric layer stack including a bottom dielectric layer portion located on the grating coupler and having an opening formed by conductor lift-off over the bottom dielectric layer portion.

According to another aspect of the present disclosure, a method of forming a solid state device may include forming a grating coupler on a substrate, forming a dielectric layer stack on the grating coupler, wherein the dielectric layer stack includes a conductor pattern over the grating coupler, and etching the conductor pattern to lift-off a portion of the dielectric layer stack and form an opening in the dielectric layer stack over the grating coupler.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1A is a side cross-sectional view a solid state device 100 according to an embodiment of the present disclosure.

FIG. 1B is a side cross-sectional view of the solid state device 100 of FIG. 1A along plane B-B′ shown in FIG. 1A.

FIG. 2 is a cross sectional view of the solid state device 100 having a first alternative design, according to one or more embodiments.

FIG. 3A is a vertical cross-sectional view of an intermediate structure including a plurality of conductor patterns 80 in the dielectric layer stack 6, according to one or more embodiments.

FIG. 3B is a plan view (top-down view) of the intermediate structure including the plurality of conductor patterns 80 in the dielectric layer stack 6, according to one or more embodiments.

FIG. 4A is a vertical cross-sectional view of an intermediate structure including a mask layer 500 on the dielectric layer stack 6, according to one or more embodiments.

FIG. 4B is a plan view (top-down view) of the intermediate structure including the mask layer 500, according to one or more embodiments.

FIG. 5A is a vertical cross-sectional view of an intermediate structure including the opening 17 in the dielectric layer stack 6, according to one or more embodiments.

FIG. 5B is a plan view (top-down view) of the intermediate structure including the opening 17, according to one or more embodiments.

FIG. 6 is a flow diagram illustrating a method of fabricating the solid state device 100 according to one or more embodiments.

FIG. 7A is a cross-sectional view of an intermediate structure in a method of forming of the solid state device 100 having a second alternative design, according to one or more embodiments.

FIG. 7B is a cross-sectional view of an intermediate structure including a plurality of openings in a method of forming of the solid state device 100 having the second alternative design, according to one or more embodiments.

FIG. 8 is a schematic illustration of alternative shapes (in a plan view) of the conductor pattern 80, according to one or more embodiments.

FIG. 9 is a plan view of additional alternative shapes of the conductor pattern 80, according to one or more embodiments.

FIG. 10 is a plan view of an alternative combination of conductor patterns 80, according to one or more embodiments.

FIG. 11A is a cross-sectional view of an intermediate structure in a method of forming of the solid state device 100 having a third alternative design, according to one or more embodiments.

FIG. 11B is a cross-sectional view of an intermediate structure including a plurality of openings in a method of forming of the solid state device 100 having the third alternative design, according to one or more embodiments.

FIG. 12 is a cross-sectional view of the solid state device 100 having a fourth alternative design, according to one or more embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

For vertical coupling of grating couplers (GCs), a non-uniform cavity reveal depth and rough surfaces may be limiting factors while using a mechanical blade process (e.g., blade dicing) to form the cavity. Control of remaining dielectric over GCs to a few nanometers may be difficult using existing methods such as plasma processing (e.g., plasma etching) of silicon or silicon plus dielectric.

In particular, the use of an existing mechanical blade process may cause a variation in height (e.g., Z height) and blade wear may cause an inconsistent cavity (e.g., opening) reveal. Further, the mechanical blade process for cavity reveal may result in rough surfaces, causing nonuniformity in epoxy dispensing (e.g., missing epoxy) and adhesion failure between a fiber array unit (FAU) and a partial cut surface (e.g., epoxy adhered to the FAU and silicon pulled from the die). Thus, the current mechanical blade process may be considered risky.

One or more embodiments of the present disclosure may include a lift-off structure and method of forming the same. The lift-off structure and method may form one or more cavities above a GC with varying shapes and depths. This may allow for nanometer level precision in cavity depth and remaining dielectric over the GC. The embodiments may provide a more robust process than the existing mechanical blade process. The embodiments may be especially applicable to silicon photonics and, in particular, for efficient coupling of light into and out of a photonic integrated circuit (photonic IC).

One or more embodiments may include a solid state device including a cavity over a grating coupler, and a method of forming the solid-state device. The method may include a first step of sequentially forming connected conductor (e.g., metal, metal nitride and/or other electrical conductor) patterns across multiple far back end of line (FBEOL) layers on the solid state device. The conductor patterns may be formed, for example, in a plurality of steps as part of a chip interconnect build. For purposes of this disclosure, the term “far back end of line” or “FBEOL” may be understood to include a portion of a solid-state processing line (e.g., semiconductor processing line) that creates a conductor layer (e.g., the under-bump-metal or redistribution layer) and associated interconnect structures forming a connection between on-chip and off-chip wiring.

The method may also include a second step of patterning a hard mask or passivation on a top-most conductor layer. One photolithography step may be used to selectively expose conductor regions that need to be etched. The method may also include a third step of etching the conductor to lift-off the material (e.g., dielectric material) that is surrounded by the conductor. The conductor may comprise a metal (e.g., Cu, Al, W, Ti, Ni, Mo, etc.) and/or an electrically conductive metal nitride (e.g., TiN, TaN, MON, WN, etc.). For example, the conductor may include metal layer(s), such as Cu layers, and metal nitride layer(s), such as TaN. The third lift-off etching step may use, for example, a highly selective wet isotropic etching of alternate layers of Cu and TaN to lift-off a part of the material (e.g., a dielectric material, such as silicon oxide).

In at least one embodiment, the solid state device may include a cavity having one or more various shapes over the GC. In at least one embodiment, the cavity may formed by using a checkerboard design including a first conductor and a second conductor in the lift-off process.

In at least one embodiment, the solid state device may include the GC in a first IC including a first substrate, such as a silicon or silicon on insulator (SOI) substrate, having a first FBEOL dielectric and conductor stack (e.g., Cu/TaN stack) thereon. A second IC including a second substrate, such as a silicon or SOI substrate, having a second FBEOL dielectric and conductor stack (e.g., Cu/TaN) thereon may be bonded face-to-face on the first FBEOL dielectric and conductor stack of the first IC. In this design, the cavity above the GC may be formed in both the first FBEOL dielectric and conductor stack in the first IC, and the second FBEOL dielectric and conductor stack in the second IC.

Various embodiments of the present disclosure may include an optical device having one or more waveguides (e.g., optical waveguides) on a substrate. The waveguides may include a waveguide core surrounded by a cladding layer having a lower refractive index than the waveguide core. In various embodiments, the waveguides may be heterogeneous, meaning that the waveguide cores may include different materials. For example, the waveguides may include a first waveguide core including a semiconductor material (e.g., silicon), and a second waveguide core including silicon nitride.

The optical device may also include a grating coupler connected to one or more waveguides, and a dielectric layer stack including a thin bottom dielectric layer portion located on the grating coupler and having an opening through the dielectric layer stack over the thin bottom dielectric layer portion. The thin bottom dielectric layer portion may have a thickness of less than 10 nm. In at least one embodiment, the thin bottom dielectric layer portion may have a thickness of less than 5 nm, such as 1 to 4 nm. The grating coupler may be optically coupled to a waveguide core of the waveguide, and may be configured to couple incident radiation into the waveguide.

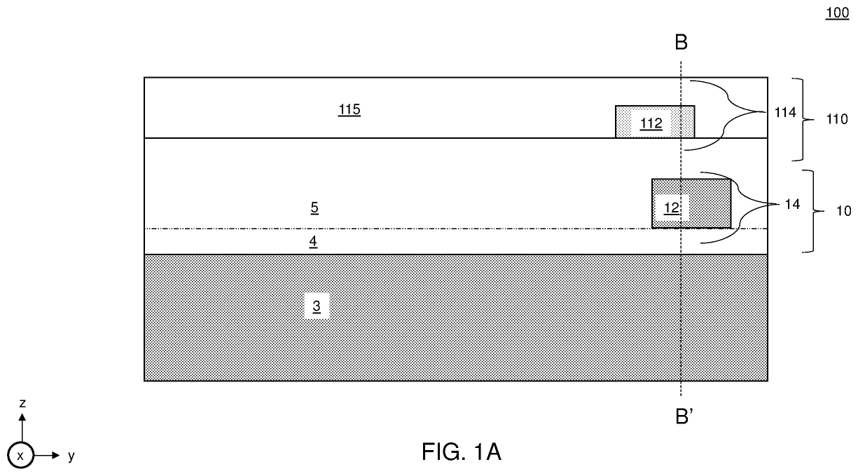

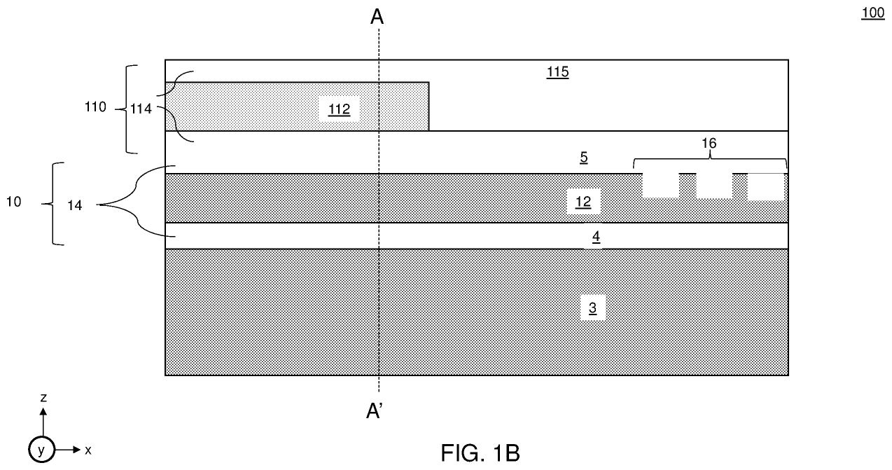

FIG. 1A is a side cross-sectional view a solid state device 100 according to an embodiment of the present disclosure. FIG. 1B is a side cross-sectional view of the solid state device 100 of FIG. 1A along plane B-B′ shown in FIG. 1A. The plane A-A′ in FIG. 1B is the plane of the solid state device shown in FIG. 1A. Referring to FIGS. 1A and 1B, the solid state device 100 may include a substrate 3. The substrate 3 may include any suitable substrate, such as a semiconductor substrate (e.g., silicon wafer), an insulating substrate, or a conductive substrate. A first cladding material layer 4 may be located over an upper surface of the substrate 3. The first cladding material layer 4 may form a portion of a cladding 14 of a first waveguide 10 to be subsequently formed. The solid state device 100 may include one or more first waveguides 10.

In some embodiments, the first cladding material layer 4 may include silicon oxide. Other suitable oxide cladding materials, such as aluminum oxide, titanium oxide, silicon oxynitride, or the like, are within the contemplated scope of disclosure. In one embodiment, a silicon-on-insulator (SOI) process may be used to form the first cladding material layer 4, as will be described in more detail below.

In another non-limiting embodiment, the first cladding material layer 4 may include silicon oxide that is formed by an oxidation process, such as a thermal or plasma oxidation process. In at least one embodiment, a silicon layer may be deposited over the substrate 3, followed by a thermal or plasma oxidation of the silicon layer at an elevated temperature. Alternatively, if the substrate 3 includes a silicon substrate, then the top surface of the substrate 3 may be oxidized by a thermal or plasma oxidation at an elevated temperature. Alternatively, the first cladding material layer 4 may be formed using a suitable deposition process, such as a chemical vapor deposition (CVD) process and/or a physical vapor deposition (PVD) process, such as sputtering.

Referring again to FIGS. 1A and 1B, a first waveguide core 12 may be located over the first cladding material layer 4. The first waveguide core 12 may be composed of a suitable semiconductor material, such as silicon. Other suitable semiconductor materials, such as silicon-germanium compound semiconductor material, are within the contemplated scope of disclosure.

In various embodiments, the first waveguide core 12 may be composed of a crystalline (i.e., single crystal or polycrystalline) silicon material. In some embodiments, the first waveguide core 12 and the first cladding material layer 4 may be formed from a silicon-on-insulator (SOI) structure that includes an epitaxial silicon layer and a buried insulator (e.g., silicon oxide) layer underlying the epitaxial silicon layer. The SOI structure may be formed using any suitable method, such as a wafer bonding method (e.g., a bond-and-etchback (BESOI) process, a Smart Cut® process, etc.), a SIMOX method that includes deep oxygen ion implantation and an anneal process to provide a buried oxide layer, or a seed method that includes forming a crystalline silicon layer over an insulator layer.

In various embodiments, the first waveguide core 12 may be fabricated by patterning a semiconductor material layer (e.g., a crystalline silicon layer) to provide the first waveguide core 12. The patterning may include forming a masking layer (e.g., photoresist or e-beam resist) over the semiconductor material layer, photolithographic or electron beam patterning of the masking layer into the desired shape, and etching the semiconductor material layer to form the first waveguide core 12. Following the etching process, the masking layer may be removed via a suitable process, such as by ashing or by dissolution using a solvent. Although the embodiment of FIGS. 1A and 1B illustrates a single first waveguide core 12, it will be understood that the semiconductor material layer may be patterned to provide multiple first waveguide cores 12 and/or other semiconductor material structures, such as a grating coupler 16 shown in FIG. 1B. The grating coupler 16 may be used to optically couple the incoming radiation into the core 12.

Referring again to FIGS. 1A and 1B, a second cladding material layer 5 may be formed over the upper surface and side surfaces of the first waveguide core 12 to provide a first waveguide 10. The first waveguide 10 may include a semiconductor material core 12 surrounded by a cladding 14. A first (i.e., lower) portion of the cladding 14 may include the first cladding material layer 4, and a second (i.e., upper) portion of the cladding 14 may include the second cladding material layer 5. The cladding 14 may have a lower refractive index than the semiconductor material core 12.

In some embodiments, the second cladding material layer 5 may include silicon oxide. Other suitable materials, such as aluminum oxide, titanium oxide, silicon oxynitride, or the like, are within the contemplated scope of disclosure. In some embodiments, the second cladding material layer 5 may be composed of the same material as the first cladding material layer 4. Alternatively, the second cladding material layer 4 and the first cladding material layer 4 may have different compositions. In some embodiments, the second cladding material layer 5 may be formed using a suitable deposition process, such as a chemical vapor deposition (CVD) process and/or a physical vapor deposition (PVD) process, such as sputtering.

In some embodiments, at least a portion of the second cladding material layer 5 may be formed via an oxidation process, such as a thermal or plasma oxidation process. For example, a silicon layer may be deposited over the first cladding material layer 4 and the semiconductor material core 12, followed by a thermal or plasma oxidation of the silicon layer at an elevated temperature. Alternatively, the top surface of the semiconductor material core 12 may be oxidized by a thermal or plasma oxidation at an elevated temperature to form the second cladding material layer 5 on top and side surfaces of the semiconductor material core 12.

Referring to FIG. 1B, the second cladding material layer 5 may also be located over the upper surface and side surfaces of the grating coupler 16. In various embodiments, a grating coupler 16 as shown in FIG. 1B may be optically coupled to the semiconductor material waveguide core 12, and may be used to couple radiation (e.g., infrared radiation or visible light) into the waveguide core 12.

Referring again to FIGS. 1A and 1B, one or more second waveguides 110 each having a second waveguide core 112 may be located over the second cladding material layer 5. In various embodiments, the second waveguide core 112 may include silicon nitride. FIG. 1B shows a pair of second waveguide cores 112 located over the second cladding material layer 5, although it will be understood that a greater or lesser number of second waveguide cores 112 may be located over the second cladding material layer 5. In addition, one or more additional structures, including waveguide cores composed of semiconductors or other materials, may be located over the second cladding material layer 5.

In various embodiments, the second waveguide core 112 may be formed by depositing a silicon nitride layer over the second cladding material layer 5 using a suitable deposition process, such as via CVD or PVD. In some embodiments, the silicon nitride layer may be deposited using a low-pressure chemical vapor deposition (LPCVD) process, although other CVD processes, including plasma enhanced chemical vapor deposition (PECVD), atomic layer deposition (ALD), and the like, may also be utilized. Suitable precursors for CVD deposition of the silicon nitride layer may include silane (SiH₄) or a silicon halide (e.g., SiCl₄, SiH₃Cl₁, SiH₂Cl₂ or SiH₁Cl₃) as a silicon precursor, and nitrogen gas (N₂) and/or ammonia (NH₄) as a nitrogen precursor. Other suitable precursors for the silicon nitride layer are within the contemplated scope of disclosure.

The second waveguide core 112 may be fabricated by patterning the silicon nitride layer. The patterning may include forming a masking layer (e.g., photoresist or e-beam resist) over the silicon nitride layer, photolithographic or electron beam patterning of the masking layer into the desired shape, and etching the silicon nitride layer to form the second waveguide core 112. Following the etching process, the masking layer may be removed via a suitable process, such as by ashing or by dissolution using a solvent.

In various embodiments, the second waveguide core 112 may be subjected to a high temperature annealing process at a temperature of at least about 750° C., such as at least about 800° C., for example 900° C. to 1200° C., for between 10 minutes and 48 hours. As discussed above, the high-temperature annealing process may facilitate the fabrication of a low loss (LL) or ultra-low loss (ULL) silicon-nitride-based waveguide. The annealing process may be performed prior to or following the patterning process described above.

Referring again to FIGS. 1A and 1B, a third cladding material layer 115 may be formed over the upper surfaces and side surfaces of each of the second waveguide cores 112. Each of the second waveguides 110 may include a silicon nitride second waveguide core 112 surrounded by a cladding 114. A first (i.e., lower) portion of the cladding 114 may be formed by the upper portion of the second cladding material layer 5, and a second (i.e., upper) portion of the cladding 114 may be formed by the third cladding material layer 115. Accordingly, the second cladding material layer 5 may form an upper portion of the cladding 14 of the first waveguide 10 and a lower portion of the cladding 114 of the second waveguide 110. The cladding 114 of the second waveguide 110 may have a lower refractive index than the first waveguide core 12 (e.g., first waveguide core may be a silicon nitride core).

In some embodiments, the third cladding material layer 115 may include silicon oxide. Other suitable materials, such as aluminum oxide, titanium oxide, silicon oxynitride, silicon oxycarbide, or the like, are within the contemplated scope of disclosure. In some embodiments, the third cladding material layer 115 may be composed of the same material as the second cladding material layer 5. Alternatively, the third cladding material layer 115 and the second cladding material layer 5 may have different compositions.

In some embodiments, the third cladding material layer 115 may be formed a chemical vapor deposition (CVD) process. In embodiments in which the third cladding material layer 115 is composed of silicon oxide, suitable precursors for deposition of the third cladding material layer 115 may include, for example, tetraethyl orthosilicate (TEOS), silane (SiH₄), silicon halide, oxygen gas, and/or nitrous oxide. Other suitable precursors are within the contemplated scope of disclosure.

In some embodiments, all or a portion of the third cladding material layer 115 may be formed using a physical vapor deposition (PVD) process, such as sputtering, or by a thermal or plasma oxidation process. Other suitable methods for forming the third cladding material layer 115 are within the contemplated scope of disclosure. In some embodiments, the third cladding material layer 115 may be photolithographically patterned and portions of the third cladding material layer 115 may be removed (e.g., via etching) from over the upper surface of the second cladding material layer 5 to provide a solid state device 100 as shown in FIGS. 1A and 1B.

In some embodiments, the second waveguide 110 may be subjected to an optional annealing process following the formation of the third cladding material layer 115. In some embodiments, the optional annealing process may be conducted at a lower temperature than the high-temperature anneal of the least one second waveguide core 112 as described above. In some embodiments, the second waveguide 110 may be subjected to a high temperature (e.g., ≥750° C.) annealing process in addition to, or as an alternative to, the high-temperature anneal of the least one second waveguide core 112 as described above.

In some embodiments, the first waveguide 10 and the second waveguide 110 may perform different functions in the solid state device 100. In some embodiments, the first waveguide 10 may extend in a direction that is not parallel to the direction of the second waveguide 110. For example, the first waveguide 10 may extend perpendicular to the second waveguide 110, as shown in FIGS. 1A and 1B. In some embodiments, the second waveguide 110 may be a low loss or ultra-low loss waveguide. The solid state device 100 may additionally include other structures and devices, including optical, electronic and/or opto-electronic structures and devices, that may be integrated on the substrate 3.

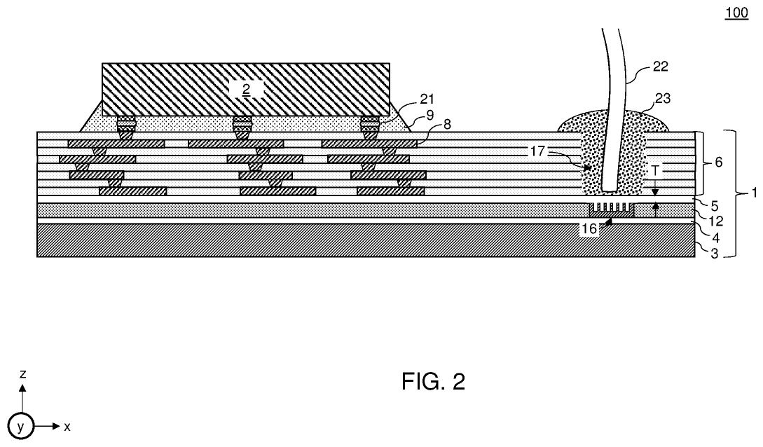

FIG. 2 is a cross sectional view of the solid state device 100 having a first alternative design, according to one or more embodiments. As illustrated in FIG. 2, in the first alternative design, the solid state device 100 may include a photonic die 1 including a photonic integrated circuit (photonic IC). The photonic die 1 may include one or more of the first waveguides 10 described above, and although it is not illustrated in FIG. 2, the photonic die 1 may also include one or more of the second waveguides 110 described above (see FIGS. 1A and 1B). The photonic die 1 may also include one or more optical switches, such as interferometers, and other optical components.

As illustrated in FIG. 2, the photonic die 1 may include the substrate 3 (e.g., silicon or SOI substrate), the first cladding layer 4, the first waveguide core 12 and second cladding layer 5. The photonic die 1 may also include a dielectric layer stack 6 on the second cladding layer 5. In at least one embodiment, the dielectric layer stack 6 may include a back end of line (BEOL) dielectric layer stack. In at least one embodiment, the dielectric layer stack 6 may include a far back end of line (FBEOL) dielectric layer stack.

The dielectric layer stack 6 may include a plurality of dielectric material layers and interconnect structures 8 (e.g., conductor lines and conductor vias) in the dielectric material layers. It should be noted that a dielectric material layer (e.g., a bottom most dielectric material layer) of the dielectric layer stack 6 may serve as the second cladding layer 5, in which case the separate second cladding layer 5 in FIG. 2 may be omitted. The dielectric material layers may include, for example, silicon dioxide or other suitable dielectric materials. In at least one embodiment, the interconnect structures 8 may include a diffusion barrier layer such as tantalum nitride or other suitable barrier materials, such as TiN, WN or MON. The interconnect structures 8 may also include a metal fill layer, such as a copper or another suitable metal material on the barrier layer.

The solid state device 100 may also include an electronic die 2 mounted on (e.g., at least partially mounted on) the photonic die 1. The electronic die 2 may be mounted on the photonic die 1, for example, by microbumps 21 or other suitable connecting structures. An underfill layer 9 may be formed between the electronic die 2 and the photonic die 1 and around the microbumps 21. The underfill layer 9 may include, for example, an epoxy material or other suitable underfill materials. The electronic die 2 may include an electronic IC that is connected to the photonic IC of the photonic die 1 by way of the interconnect structures 8. The electronic die 2 may function as a control circuit for various switching elements (e.g., interferometers, etc.) in the photonic die 1.

As further illustrated in FIG. 2, the grating coupler 16 described above may be formed on and optically coupled to the first waveguide core 12. The dielectric layer stack 6 may include an opening 17 over the grating coupler 16. One or more optical fibers 22 may be located in the opening 17 over the grating coupler 15. The optical fiber 22 may be fixed in the opening 17 by an optical adhesive 23 that may surround the optical fiber 22 in the opening 17. An end of the optical fiber 22 in the opening 17 may be optically coupled to the grating coupler 16. Optical signals in the optical fiber 22 may be transmitted to the first waveguide core 12 by way of the grating coupler 16. Optical signals in the first waveguide core 12 may be transmitted to the optical fiber 22 by way of the grating coupler 16.

As illustrated in FIG. 2, a bottom of the opening 17 may be separated (in the z-direction) from the grating coupler 16 by a distance T. The distance T may be less than 10 nm, although other distances are contemplated by this disclosure. In at least one embodiment, the distance T may be less than 5 nm, such as 1 to 4 nm. The distance T may be constituted by, for example, a thickness of the second cladding layer 5. In the case where the second cladding layer 5 is omitted and replaced by a dielectric material layer of the dielectric layer stack 6, then the distance T may be constituted by a thickness of the dielectric material layer.

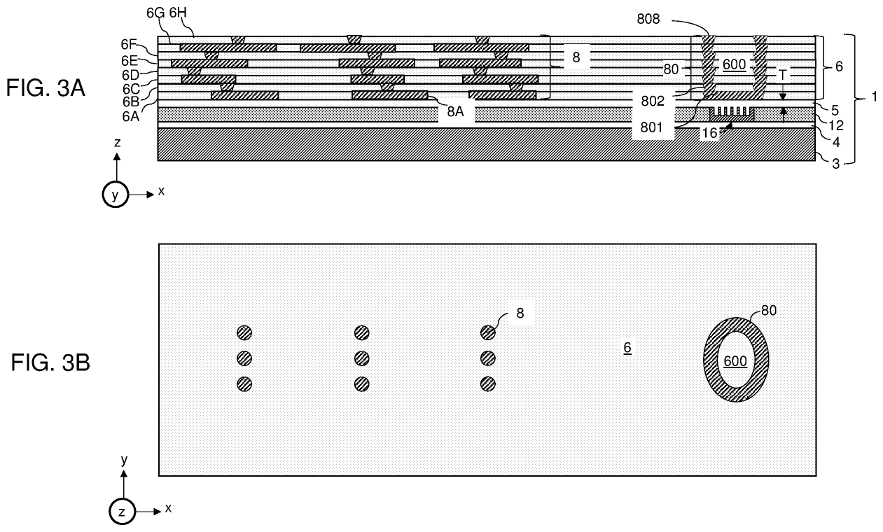

FIGS. 3A-5B illustrate various intermediate structures in a method of forming the solid state device 100 having the first alternative design, according to one or more embodiments. In particular, FIG. 3A is a vertical cross-sectional view of an intermediate structure including a plurality of conductor patterns 80 in the dielectric layer stack 6, according to one or more embodiments. As illustrated in FIG. 3A, the dielectric layer stack 6 may be formed sequentially (e.g., layer-by-layer) on the second cladding layer 5. The conductor lines and conductor vias of the interconnect structures 8 may be formed sequentially along with the dielectric material layers (e.g., 6A to 6H) either by a damascene process in recesses in the dielectric layers 6A-6H or by etching conductor layers and depositing the dielectric layers 6A-6H around the etched conductor layers.

In addition, a conductor pattern 80 may be formed sequentially along with the forming of the conductor lines and conductor vias of the interconnect structures 8. The conductor pattern 80 may be formed over the grating coupler 16. The conductor layers 801 to 808 of the conductor pattern 80 may be formed in the plurality of dielectric material layers 6A-6H of the dielectric layer stack 6, respectively (e.g., one layer 801 of the conductor pattern 80 is formed in one respective dielectric material layer 6A). A respective conductor pattern layer (e.g., 801) may be formed (e.g., simultaneously formed) in a corresponding dielectric material layer (e.g., 6A) with the forming of a conductor layer (e.g., 8A) of an interconnect structure 8 in the same dielectric material layer (e.g., 6A). That is, a conductor layer (e.g., 8A) of an interconnect structure 8 and a corresponding conductor pattern 80 (e.g., conductor pattern layer 801) may be formed at the same time in the same dielectric material layer (e.g., 6A) using the materials and the same process steps (e.g., photolithography, etching and planarization process steps).

The conductor pattern 80 layers 801-808 may be connected to each other in the dielectric layer stack 6. That is, one conductor pattern layer (e.g., 802) in a particular dielectric material layer (e.g., 6B) may be formed on and directly contact the conductor pattern layer (e.g., 802) in a dielectric material layer (e.g., 6A) immediately beneath the particular dielectric material layer (e.g., 6B). The conductor patterns 80 may be formed, for example, so as to surround a lift-off portion 600 (e.g., dielectric material lift-off portion) of the dielectric layer stack 6. In at least one embodiment, the lift-off portion 600 may include a material other than a dielectric material. In at least one embodiment, the conductor patterns 80 may include a barrier layer such as tantalum nitride or other suitable barrier materials, and a metal fill material, such as copper or other suitable metal materials on the barrier layer. As illustrated in FIG. 3A, an outermost width in the x-direction of the conductor patterns 80 may be equal to or greater than a width of the grating coupler 16.

It should be noted that the lowermost conductor pattern layer 801 may be formed in the lowermost dielectric material layer 6A of the dielectric layer stack 6. That is, the lowermost conductor pattern layer 801 may be formed on the upper surface of the second cladding layer 5. Thus, a bottom surface of the lowermost conductor pattern layer 801 may be separated from the grating coupler 16 by the distance T.

FIG. 3B is a plan view (top-down view) of the intermediate structure of FIG. 3A including the conductor pattern 80 in the dielectric layer stack 6, according to one or more embodiments. As illustrated in FIG. 3B, the conductor pattern 80 may surround the lift-off portion 600 of the dielectric layer stack 6 in the plan view.

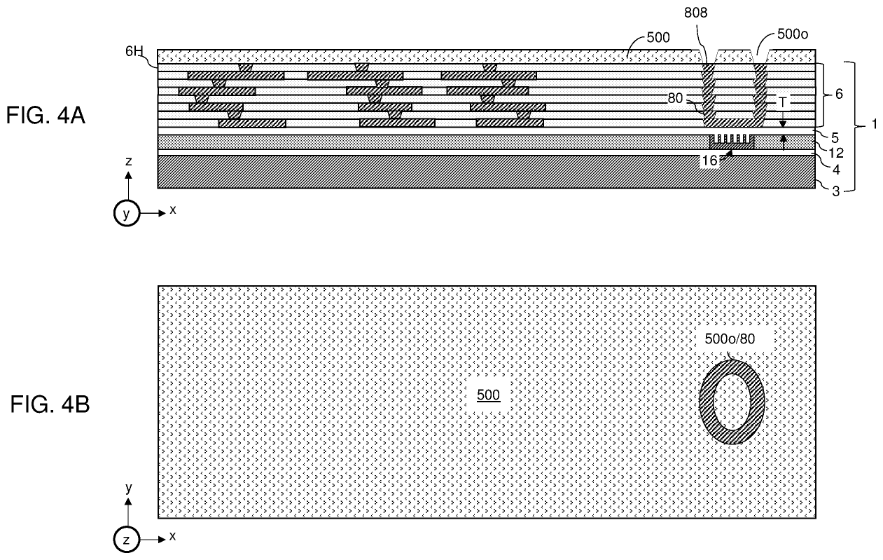

FIG. 4A is a vertical cross-sectional view of an intermediate structure including a mask layer 500 on the dielectric layer stack 6, according to one or more embodiments. The method of one or more embodiments may include a second step of patterning the mask layer 500 which may comprise a photoresist mask layer, a hard mask layer and/or or passivation mask layer on a top-most conductor layer 808. One or more photolithography steps may be used to selectively expose conductor regions that need to be etched.

As illustrated in FIG. 4A, the mask layer 500 (e.g., photoresist layer, hard mask, passivation mask layer, etc.) may be deposited (e.g., by spin-coating, CVD, PVD, etc.) on an uppermost dielectric material layer 6H in the dielectric layer stack 6. The mask layer 500 may then be patterned to form one or more openings 5000 in the mask layer 500. For example, if the mask layer 500 comprises a hard mask layer (e.g., a metal hard mask layer, a dielectric hard mask layer (e.g., carbon, metal oxide or silicon nitride layer), then the hard mask layer may be etched using a patterned photoresist layer as a mask. If the mask layer 500 comprises a photoresist layer, then it may be patterned by photolithographic exposure and then developed.

FIG. 4B is a plan view (top-down view) of the intermediate structure including the mask layer 500, according to one or more embodiments. As illustrated in FIG. 4B, a location of the opening 5000 may correspond to a location of the conductor pattern 80 in the uppermost dielectric material layer 6H. In particular, a shape (e.g., circular shape, oval shape, etc.) of the opening 5000 in the plan view may be substantially the same as a shape of the conductor pattern 80 in the plan view. That is, the inner and outer boundaries of the opening 5000 may be substantially aligned (in the z-direction) with the inner and outer boundaries of the conductor pattern 80. Thus, in a plan view, an upper surface of the conductor pattern 80 in the uppermost dielectric material layer may be exposed through the opening 5000.

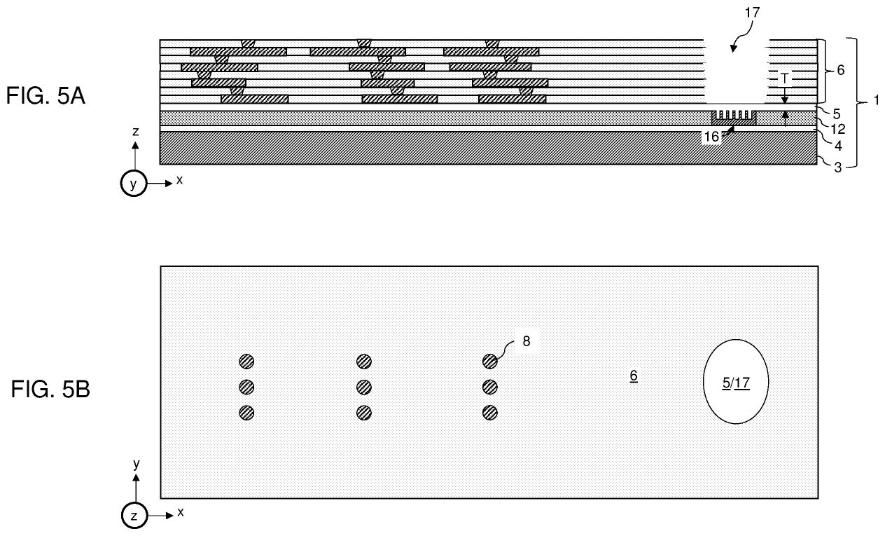

FIG. 5A is a vertical cross-sectional view of an intermediate structure including the opening 17 in the dielectric layer stack 6, according to one or more embodiments. The method may also include a third step of selectively etching the conductor pattern 80 to lift-off the dielectric material portion 600 that is surrounded by the conductor pattern 80. This step may use, for example, a highly selective wet isotropic etching of alternate layers of Cu and TaN exposed in the opening 5000 in the mask layer 500 to lift-off part the dielectric material portion 600 which is surrounded by the conductor pattern 80 on the bottom and on the sides.

As illustrated in FIG. 5A, the conductor pattern 80 may be etched (e.g., by wet etching, dry etching, etc.) through the opening 5000 in the mask layer 500 in a lift-off process. The lift-off process may also remove the lift-off dielectric material portion 600 surrounded by the conductor pattern 80. The lift-off process result in the formation of the opening 17 (e.g., cavity) in the dielectric layer stack 6. As illustrated in FIG. 5A, a wall of the opening 17 may correspond to an outermost sidewall of the conductor pattern 80 removed in the lift-off process.

Further, a bottom of the opening 17 may correspond to the previous location of the bottom of the lowermost layer 801 of the conductor pattern 80. That is, the bottom of the opening 17 may be constituted by the upper surface of the second cladding layer 5. Thus, the bottom of the opening 17 may be separated from the grating coupler 16 by the distance T.

FIG. 5B is a plan view (top-down view) of the intermediate structure including the opening 17, according to one or more embodiments. As illustrated in FIG. 5B, the upper surface of the second cladding layer 5 may be exposed through the opening 17 in the dielectric layer stack 6.

After forming the opening 17, the mask layer 500 may be removed, for example, by ashing or selective etching. Processing may then continue to form the solid state device 100 as illustrated in FIG. 2. In particular, the electronic die 2 may be bonded to the photonic die 1, and the optical fiber 22 may be fixed in the opening 17 with the optical adhesive 23.

In one or more embodiments, the lift-off process illustrated in FIGS. 3A-5B may be used to form one or more openings 17 (e.g., cavities) above the grating coupler 16 with varying shapes and depths. This may allow for nanometer level precision in cavity depth and remaining dielectric (e.g., having a thickness T) over the grating coupler 16. Thus, the lift-off process may enable a more robust process than the existing mechanical blade process.

Further, the lift-off process may provide a substantially uniform height (e.g., in the z-direction) of the opening 17 (e.g., uniform depth of the opening) and provide a consistent opening. Further, the lift-off process may provide the bottom and sidewall of the opening 17 with a smooth surface, allowing for uniformity in epoxy dispensing and good adhesion between optical adhesive 23 around the optical fiber 21 (e.g., a fiber array unit (FAU)) and the sidewall of the opening 17.

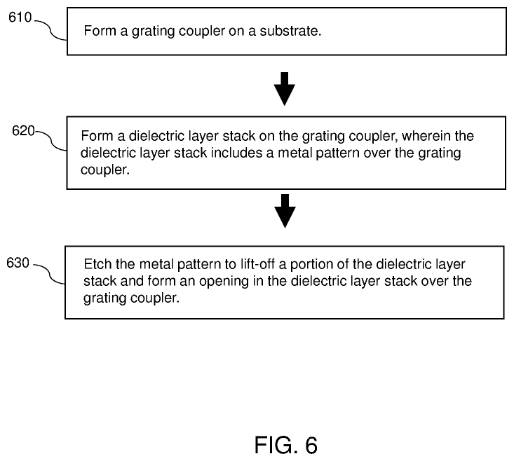

FIG. 6 is a flow diagram illustrating a method of fabricating the solid state device 100 according to one or more embodiments. Step 610 may include forming a grating coupler 16 on a substrate (e.g., directly on a surface of a substrate or separated from a surface of the substrate by one or more intervening layers). Step 620 may include forming a dielectric layer stack 6 on the grating coupler 16, wherein the dielectric layer stack 6 includes a conductor pattern 80 over the grating coupler 16. Step 630 may include etching the conductor pattern 80 to lift-off a portion of the dielectric layer stack (e.g., the lift-off portion 600 surrounded by the conductor pattern 80) and form an opening 17 in the dielectric layer stack 6 over the grating coupler 16.

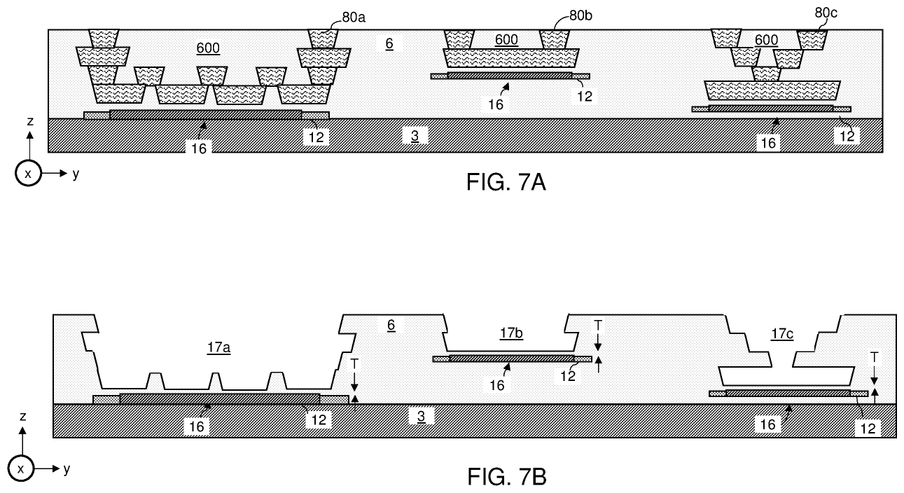

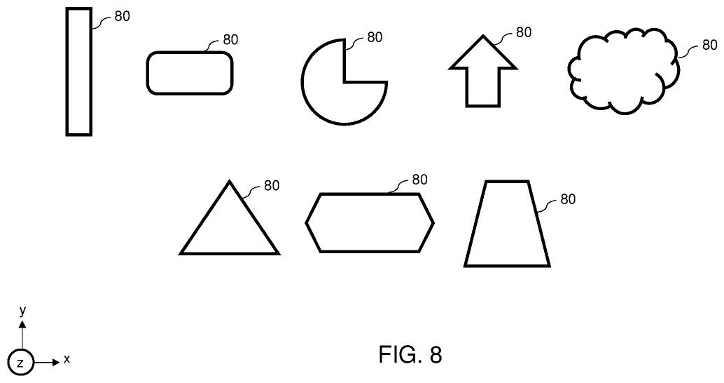

FIG. 7A is a cross-sectional view of an intermediate structure in a method of forming of the solid state device 100 having a second alternative design, according to one or more embodiments. As illustrated in FIG. 7A, in the second alternative design, the solid state device 100 may be formed by forming a plurality of conductor patterns in the dielectric layer stack 6. The plurality of conductor patterns may include a first conductor pattern 80a, a second conductor pattern 80b and a third conductor pattern 80c.

FIG. 7B is a cross-sectional view of an intermediate structure including a plurality of openings in a method of forming of the solid state device 100 having the second alternative design, according to one or more embodiments. The intermediate structure in FIG. 7B may be formed by performing a lift-off process on the intermediate structure of FIG. 7A. As illustrated in FIG. 7B, after the lift-off process, the intermediate structure may include a plurality of openings corresponding to the plurality of conductor patterns, respectively. In particular, the intermediate structure in FIG. 7B may include opening 17a resulting from performing a lift-off process on conductor pattern 80a, opening 17b resulting from performing a lift-off process on conductor pattern 80b, and opening 17c resulting from performing a lift-off process on conductor pattern 80c. In at least one embodiment, the opening 17a, opening 17b and opening 17c may be formed (e.g., simultaneously formed) in one lift-off process (e.g., one patterned mask layer formed on the dielectric layer stack 6, and one etch step for removing the conductor patterns 80a, 80b and 80c and lifting off the lift-off portions 600 surrounded thereby) to expose a plurality of grating couplers 16.

FIG. 8 is a schematic illustration of alternative shapes (in a plan view) of the conductor pattern 80, according to one or more embodiments. As illustrated in FIG. 8, the conductor patterns 80 may have many different shapes in a plan view. For example, as an alternative to the oval-shaped conductor pattern 80 in FIG. 3B, the conductor pattern 80 may have a rectangular shape, partial circular shape, arrow shape, cloud shape, triangle shape, rhombus shape, and so on.

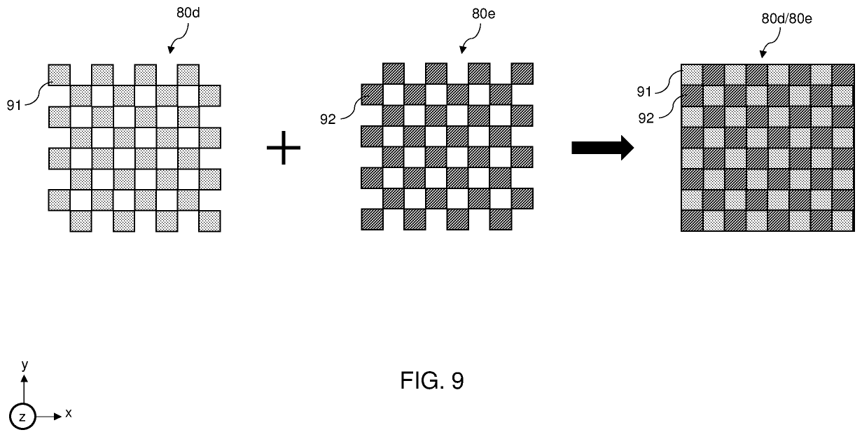

FIG. 9 is a plan view of additional alternative shapes of the conductor pattern 80, according to one or more embodiments. The conductor patterns 80 described above may include shapes having a linear outline. For example, the oval-shaped conductor pattern 80 in FIG. 3B may have a linear outline, and each of the alternative shapes of the conductor pattern 80 in FIG. 8 may have a linear outline. However, as illustrated in FIG. 9, the conductor pattern 80 used in the method of forming the solid state device 100 may not necessary have a linear outline.

In particular, the conductor pattern 80d may include a plurality of conductor squares 91 formed in a first dielectric material layer of the dielectric layer stack 6 in a first checkerboard arrangement. The conductor pattern 80e may include a plurality of conductor squares 92 formed in a second dielectric material layer of the dielectric layer stack 6 in a second checkerboard arrangement. The conductor squares 92 may include a conductor material that is the same as or different than the conductor material of the conductor squares 91.

The second dielectric material layer may be directly above the first dielectric material layer in the dielectric layer stack 6. The second checkerboard arrangement may have a design that is complementary to the first checkerboard arrangement. Thus, in a plan view, the conductor pattern 80e may overlap the conductor pattern 80d so that the conductor squares 92 are located in a position not occupied by the conductor squares 91, and vice versa, forming the combination conductor pattern 80d/80e. In at least one embodiment, a plurality of conductor patterns 80d and a plurality of conductor patterns 80e may be alternatingly formed in the z-direction in the dielectric material layers of the dielectric layer stack 6. A benefit to the conductor pattern design in FIG. 9 is that the lift-off process (e.g., including an etching step) may be performed at any location on the combination conductor pattern 80d/80e to remove the part of the first dielectric material layer between the conductor squares 91, and to remove the part of the second dielectric material layer between the conductor squares 92.

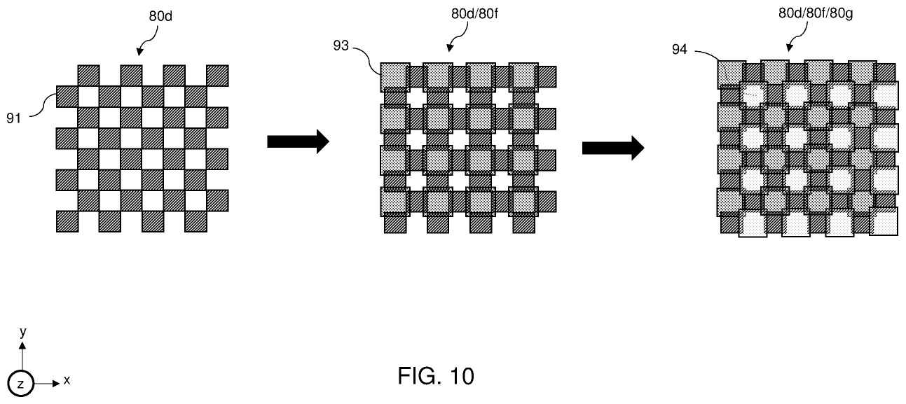

FIG. 10 is a plan view of an alternative combination of conductor patterns 80, according to one or more embodiments. In FIG. 10, the conductor pattern 80d including the plurality of conductor squares 91 formed in a first dielectric material layer, may be combined with a conductor pattern 80f including a plurality of conductor squares 93 formed in a second dielectric layer to form the combination conductor pattern 80d/80f. As illustrated in FIG. 10, the conductor squares 93 may overlap the conductor squares 91 in the plan view. The combination conductor pattern 80d/80f may be combined with a conductor pattern 80g including a plurality of conductor squares 94 formed in a third dielectric layer to form the combination conductor pattern 80d/80f/80g. As illustrated in FIG. 10, the conductor squares 94 may overlap the conductor squares 91 and the conductor squares 93 in the plan view. As in FIG. 9, in FIG. 10 the lift-off process (e.g., including an etching step) may be performed at any location on the combined checkerboard design 80d/80f/80g to remove the part of the first dielectric material layer between the conductor squares 91, to remove the part of the second dielectric material layer between the conductor squares 93, and to remove the part of the third dielectric material layer between the conductor squares 94.

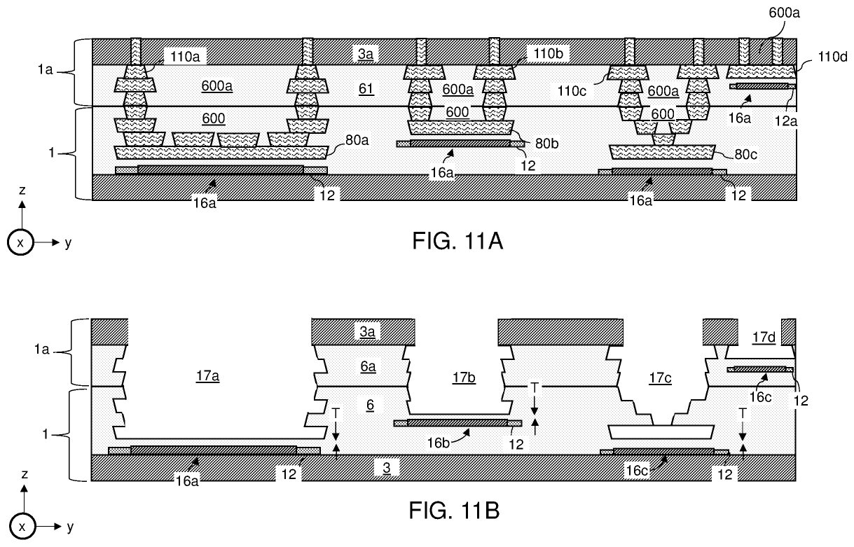

FIG. 11A is a cross-sectional view of an intermediate structure in a method of forming of the solid state device 100 having a third alternative design, according to one or more embodiments. As illustrated in FIG. 11A, in the third alternative design, the solid state device 100 may include a second photonic die 1a bonded to the photonic die 1. The second photonic die 1a may include a substrate 3a (e.g., silicon, SOI, etc.) and a dielectric layer stack 61 on the substrate 3a. The second photonic die 1a may also include a plurality of conductor patterns in the dielectric layer stack 61 on the substrate 3a. In particular, the second photonic die 1a may include conductor pattern 110a, conductor pattern 110b, conductor pattern 110c and conductor pattern 110d. Further, lift-off portions 600a may be surrounded by the conductor patterns 110a, 110b, 110c and 110d. The photonic die 1a may also include a waveguide 12a with a grating coupler 16a associated with the conductor pattern 110d.

The second photonic die 1a may be bonded to the photonic die 1 in a face-to-face configuration. That is, the dielectric layer stack 61 in photonic die 1a may be bonded to the dielectric layer stack 6 in photonic die 1. In addition, the conductor pattern 110a, conductor pattern 110b and conductor pattern 110c in photonic die 1a may be bonded to conductor pattern 80a, conductor pattern 80b and conductor pattern 80c in photonic die 1, respectively. That is, the photonic die 1a may be bonded to the photonic die 1 by a hybrid bonding process in which the dielectric material in the dielectric layer stack 61 is bonded to the dielectric material in the dielectric layer stack 6, and the conductor patterns 110a, 110b, 110c are bonded to the conductor patterns 80a, 80b, 80c.

FIG. 11B is a cross-sectional view of an intermediate structure including a plurality of openings in a method of forming of the solid state device 100 having the third alternative design, according to one or more embodiments. The intermediate structure in FIG. 11B may be formed by performing a lift-off process on the intermediate structure of FIG. 11A. As illustrated in FIG. 11B, after the lift-off process, the intermediate structure may include a plurality of openings corresponding to the plurality of conductor patterns, respectively. In particular, the intermediate structure in FIG. 11B may include opening 17a resulting from performing a lift-off process on combination conductor pattern 80a/110a, opening 17b resulting from performing a lift-off process on combination conductor pattern 80b/110b, opening 17c resulting from performing a lift-off process on combination conductor pattern 80c/110c, and opening 17d resulting from performing a lift-off process on conductor pattern 110d. In at least one embodiment, the opening 17a, opening 17b, opening 17c and opening 17d may be formed (e.g., simultaneously formed) in one lift-off process (e.g., one patterned mask layer formed on the substrate 3a, and one etch step for removing the combination conductor patterns 80a/110a, 80b/110b and 80c/110c and the conductor pattern 110d, and lifting off the lift-off portions 600 and lift-off portions 600a surrounded thereby).

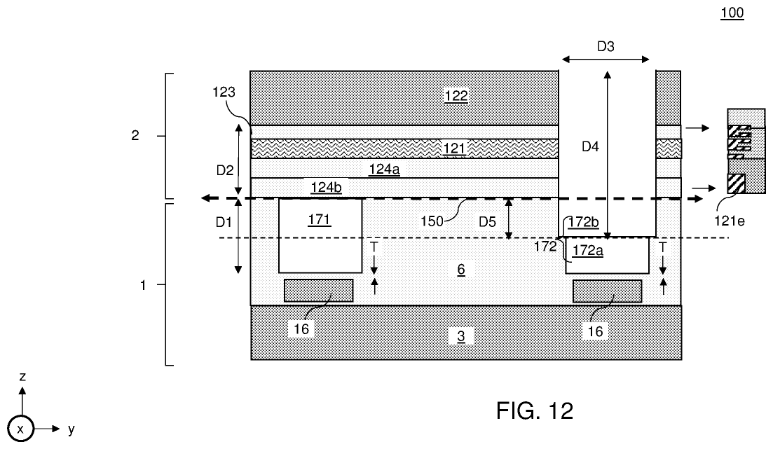

FIG. 12 is a cross-sectional view of the solid state device 100 having a fourth alternative design, according to one or more embodiments. As illustrated in FIG. 12, in the fourth alternative design the solid state device 100 may include the photonic die 1 bonded to the electronic IC die 2 at a bonding interface 150.

The photonic die 1 may include the substrate 3. The substrate 3 may include, for example, a photonic IC substrate having a thickness of about 500 to 1000 μm. One or more above described waveguides may be formed on the substrate 3, and one or more grating couplers 16 may be formed on the waveguides, respectively. The dielectric layer stack 6 may be formed on the substrate 3 and on the grating couplers 16.

The electronic IC die 2 may include a substrate 122. The substrate 122 may include, for example, an electronic IC wafer (e.g., silicon wafer or portion thereof) having a thickness of about 25 to 100 μm after thinning. A bulk electronic device layer 121 (e.g., silicon on insulator layer) may be located over the substrate 122. An intervening insulating layer 123, such as a silicon oxide layer, may be located between the bulk electronic device layer 121 and the substrate 122. The bulk electronic device layer 121 may include electronic devices 121e, such as transistors, diodes, etc., and their electrodes and interconnects located thereon or therein. One or more insulating layers 124a, 124b may be located over the bulk electronic device layer 121. The upper most insulating layer 124b may be bonded to the dielectric layer stack 6 of the photonic die 1.

The solid state device 100 may also include a first vertical groove 171 having a first height D1 (in the z-direction) of about 5 to 15 μm. The first vertical groove 171 may be formed, for example, by the lift-off process described above (e.g., see FIGS. 3A-5B). Therefore, the first vertical groove 171 may be separated from the underlying grating coupler 16 by a thin bottom dielectric layer portion having the thickness T which may be less than 10 nanometers. A portion of the layers 121, 122, 123, 124a, and 124b above the first vertical groove 171 may have a thickness D2 which is greater than the thickness D1. The thickness D2 may be 3 to 10 μm.

The solid state device 100 may also include a second vertical groove 172 including a lower second vertical groove portion 172a and an upper second vertical groove portion 172b. A bottom of the lower second vertical groove portion 172a may be substantially aligned with a bottom of the first vertical groove 171. The second vertical groove 172 may be formed, for example, by a lift-off process described above (e.g., see FIGS. 3A-5B). Therefore, the lower second vertical groove portion 172a may also be separated from the underlying grating coupler 16 by a thin bottom dielectric layer portion having the thickness T which may be less than 10 nanometers.

The upper second vertical groove portion 172b may have a width D3 (in the y-direction) of about 4,000 to 6,000 μm. The lower second vertical groove portion 172a may have a width (in the y-direction) less than the width D3 of the upper second vertical groove portion 172b. The upper second vertical groove portion 172b may have a height D4 (in the z-direction) of 50 to 80 μm. A bottom of the upper second vertical groove portion 172b may be located about the midpoint (in the z-direction) of the first vertical groove 171. Thus, a distance D5 in the z-direction between the bottom of the upper second vertical groove portion 172b and the upper end of the first vertical groove 171 may be about half the height of the first vertical groove 171.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

It is also understood that the examples and embodiments described herein are for illustrative purposes only and that various modifications or changes in light thereof will be suggested to persons skilled in the art and are to be included within the spirit and purview of this application and scope of the appended claims.

It will be understood that, although the terms first, second, etc. are, in some instances, used herein to describe various elements, these elements should not be limited by these terms. These terms are used only to distinguish one element from another. The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “if” is, optionally, construed to mean “when” or “upon” or “in response to determining” or “in response to detecting” or “in accordance with a determination that,” depending on the context.

1. A solid state device, comprising:
a waveguide located on a substrate;
a grating coupler connected to the waveguide; and
a dielectric layer stack including a bottom dielectric layer portion located on the grating coupler and having an opening formed by conductor lift-off located over the bottom dielectric layer portion.

2. The solid state device of claim 1, wherein the bottom dielectric layer portion has a thickness of less than 10 nm.

3. The solid state device of claim 1, wherein the waveguide comprises a core and a cladding surrounding the core, and the grating coupler is optically coupled to the core.

4. The solid state device of claim 1, wherein the solid state device comprises a bonded assembly of a photonic integrated circuit die and an electronic integrated circuit die.

5. The solid state device of claim 4, wherein the grating coupler and the waveguide are located in the photonic integrated circuit die.

6. The solid state device of claim 5, further comprising an optical fiber located in the opening.

7. The solid state device of claim 6, wherein:
the opening extends through a substrate of the electronic integrated circuit die;
the optical fiber extends in the opening through the substrate of the electronic integrated circuit die;
the optical fiber is optically coupled to the grating coupler; and
the grating coupler is configured to couple radiation between the optical fiber and the waveguide.

8. A method of forming a solid state device, comprising:
forming a grating coupler on a substrate;
forming a dielectric layer stack on the grating coupler, wherein the dielectric layer stack includes a conductor pattern over the grating coupler; and
etching the conductor pattern to lift-off a portion of the dielectric layer stack and form an opening in the dielectric layer stack over the grating coupler.

9. The method of claim 8, wherein the dielectric layer stack comprises a plurality of dielectric layers, and the step of forming the conductor pattern comprises sequentially forming a plurality of conductor layers in the plurality of dielectric layers.

10. The method of claim 9, wherein the step of forming the conductor pattern comprises sequentially forming a plurality of connected conductor layers in the plurality of dielectric layers, respectively.

11. The method of claim 10, wherein sequentially forming the connected conductor layers comprises are formed at a same time as forming conductive interconnect layers in the plurality of dielectric layers.

12. The method of claim 9, wherein the step of forming the plurality of conductor layers comprises forming a plurality of far back end of line (FBEOL) conductor layers.

13. The method of claim 9, wherein the step of forming the plurality of conductor layers comprises alternately forming copper layers and tantalum nitride layers.

14. The method of claim 9, further comprising patterning a hard mask on a topmost conductor layer of the plurality of conductor layers to expose a region of the plurality of conductor layers to be etched, wherein the etching of the conductor pattern comprises etching the plurality of conductor layers using the hard mask.

15. The method of claim 8, wherein the etching of the conductor pattern comprises a selective wet isotropic etching of the conductor pattern to lift-off the portion of the dielectric layer stack surrounded by the conductor pattern.

16. The method claim 8, wherein the solid state device comprises a photonic integrated circuit die.

17. The method of claim 16, further comprising forming a waveguide on a substrate, wherein the step of forming the grating coupler comprises forming the grating coupler connected to the waveguide.

18. The method of claim 17, further comprising placing an optical fiber in the opening.

19. The method of claim 18, further comprising bonding an electronic integrated circuit die to the photonic integrated circuit die.

20. The method of claim 19, wherein:
the opening extends through a substrate of the electronic integrated circuit die;
the optical fiber extends in the opening through the substrate of the electronic integrated circuit die;
the optical fiber is optically coupled to the grating coupler; and
the grating coupler is configured to couple radiation between the optical fiber and the waveguide.
